(19) United States
(12) Patent Application Publication
(10) Pub. No.: US 2013/0198154 A1
(43) Pub. Date: Aug. 1, 2013

(54) METHOD AND SYSTEM FOR MANAGING DATABASE APPLICATIONS

(71) Applicants: Abigail Welborn, Redmond, WA (US); Mark Boulter, Redmond, WA (US); Sean Olson, Redmond, WA (US); Saurin Shah, Redmond, WA (US); Aravind Ranganathan, Redmond, WA (US); Ela Yildizer Genc, Redmond, WA (US); Michael Smith, Redmond, WA (US)

(72) Inventors: Abigail Welborn, Redmond, WA (US); Mark Boulter, Redmond, WA (US); Sean Olson, Redmond, WA (US); Saurin Shah, Redmond, WA (US); Aravind Ranganathan, Redmond, WA (US); Ela Yildizer Genc, Redmond, WA (US); Michael Smith, Redmond, WA (US)

(73) Assignee: Microsoft Corporation, Redmond, WA (US)

(21) Appl. No.: 13/606,971

(22) Filed: Sep. 7, 2012

Related U.S. Application Data
(60) Provisional application No. 61/591,191, filed on Jan. 26, 2012.

(51) Int. Cl. G06F 7/00; G06F 17/30

(52) U.S. Cl. 707/695; 707/E17.005; 707/E17.032

(57) ABSTRACT

A method for processing a database application component modification request includes receiving a request to modify a database application component of a database application, initiating the database application component modification, sending a response including instructions for accessing a database application component definition including the database application component modification, wherein the database application component definition is provided as a locally accessible temporary copy of the database application component.

### CROSS REFERENCE TO RELATED APPLICATIONS

The present application claims priority to U.S. Provisional Patent Application Ser. No. 61/591,191, filed Jan. 26, 2012, the entire content of which is hereby incorporated by reference.

### BACKGROUND

Current database applications allow a user to manipulate data in a variety of ways. A database application can be used to organize and maintain data associated with the many different applications. To access information in a database, a user may utilize a database management system. A database management system may be implemented in software that serves as an interface between the user and a database. The database management system may manage requests for database action. For instance, to facilitate access to information in the database, the database management system typically includes operations to perform searching, querying, sorting, updating and combining data in the database.

### SUMMARY

This summary is provided to introduce a selection of concepts in a simplified form that are further described below in the Detailed Description section. This summary is not intended to identify key features or essential features of the disclosure subject matter, nor is it intended to be used as an aid in determining the scope of the disclosure.

Embodiments of the present disclosure enable methods and systems for creation and/or modification of a database application. Methods and systems according to embodiments of the disclosure further enable creation and/or modification of a database object. Database applications or database objects may be created or modified via a database management system, but may reside on an external server or external storage service. Creation and/or modification of a database application or object may be accomplished by the database management system contacting the server. The server may receive a request from the database management system to create and/or modify a database application or database object, and may provide a response including instructions for accessing a temporary local copy of the database application or database object. Additionally, embodiments enable a server to receive a database application information request or database object information request from a client and provide the requested database application information or database object information to the client. Methods and systems according to embodiments of the disclosure further enable a client application to determine one or more database application behaviors for a database application residing on the server and obtain a database application package describing one or more features of the database application residing on the server. Methods and systems according to embodiments of the disclosure further provide database application and object versioning information for use when designing a database application or database object.

An embodiment of the present disclosure includes a method for processing a database application component modification request comprising receiving a request to modify a database application component of a database application, initiating the database application component modification, and sending a response including instructions for accessing a database application component definition including the database application component modification, wherein the database application component definition is provided as a locally accessible temporary copy of the database application component.

A further embodiment of the present disclosure includes a computer readable storage medium comprising computer readable instructions for receiving a request to modify a database application component of a database application, initiating the database application component modification, and sending a response including instructions for accessing a database application component definition including the database application component modification, wherein the database application component definition is provided as a locally accessible temporary copy of the database application component.

A further embodiment of the present disclosure includes a method for requesting a database application component modification including sending a request to modify a database application component of a database application, receiving an indication that the database application component modification has been initiated, and receiving a response including instructions for accessing a database application component definition including the database application component modification, wherein the database application component definition is received as a locally accessible temporary copy of the database application component.

Embodiments disclosed herein may be implemented as a computer process, a computing system, or an article of manufacture such as a computer program product or computer readable media. The computer program product may be computer storage media readable by a computer system and encoding a computer program of instructions for executing a computer process. The computer program product may also be a propagated signal on a carrier readable by a computing system and encoding a computer program of instructions for executing a computer process.

### BRIEF DESCRIPTION OF THE DRAWINGS

Non-limiting and non-exhaustive embodiments are described with reference to the following figures in which:

FIG. 1 illustrates a system for creating and modifying database applications and objects according to one or more embodiments disclosed herein;

FIG. 2 illustrates a method for creating and modifying database applications according to one or more embodiments disclosed herein;

FIGS. 3A-3B illustrate examples of received database object requests according to one or more embodiments disclosed herein;

FIG. 4 illustrates a tablet computing device executing one or more embodiments disclosed herein;

FIG. 5 illustrates a block diagram of a computing environment suitable for implementing one or more embodiments disclosed herein;

FIG. 6A illustrates one embodiment of a mobile computing device executing one or more embodiments disclosed herein;

FIG. 6B is a simplified block diagram of an exemplary mobile computing device suitable for practicing one or more embodiments disclosed herein; and

FIG. 7 is a simplified block diagram of an exemplary distributed computing system suitable for practicing one or more embodiments disclosed herein.

### DETAILED DESCRIPTION

Various embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

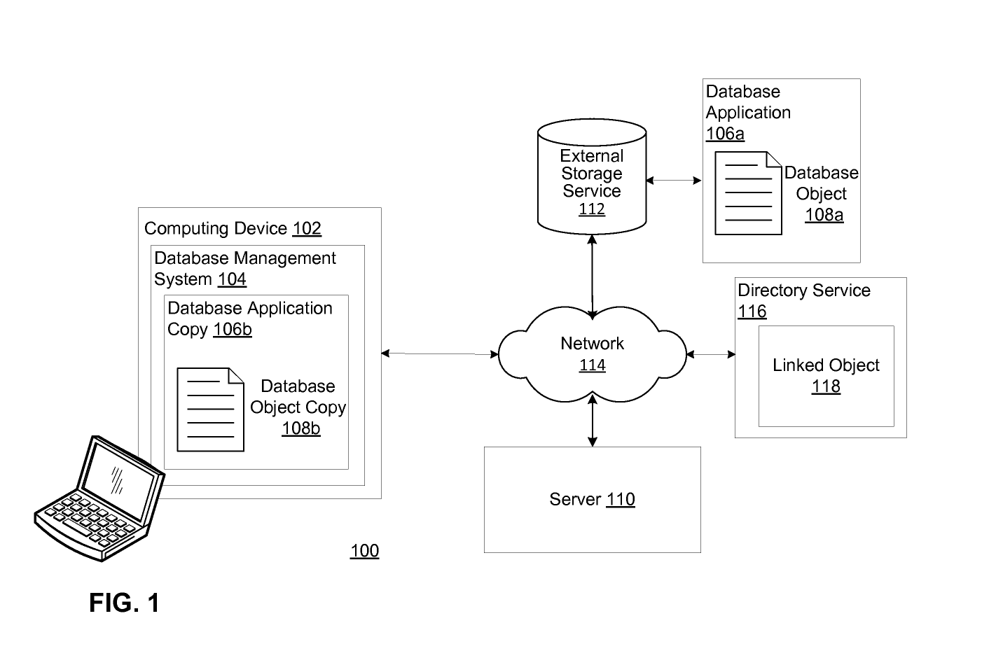

FIG. 1 illustrates a system 100 for processing database component modification requests. A database component modification request may include a request to create and/or modify database applications and objects. Modification requests may be made via a client operating on a computing device and connected to one or more servers according to one or more embodiments. As shown in FIG. 1, the system 100 may be implemented on a client computing device 102 (such as a local computing device) including a client (e.g., database management system 104) configured to access a database application copy 106b or a database object copy 108b retrieved from a server 110. Accessed database application copy 106b or database object copy 108b may facilitate generation of a request to the server 110. The local computing device 102 may be a desktop or laptop computer, tablet computer, smartphone, personal digital assistant or the like. In certain embodiments, database management system 104 may be a desktop or web-based data management application. In certain embodiments, database management system 104 may be a standard off-the-shelf database management system such as, for example, any version of ACCESS® by Microsoft® Corporation of Redmond, Wash. Database management system 104 may support the structured query language (SQL) for querying, updating, and managing the database. In addition to supporting SQL, database management system 104 may further provide extensions to SQL as well as additional user interface features to simplify operations on a database.

In embodiments, server 110 is configured to: (i) receive requests to create or modify a database application 106a or database object 108a, (ii) initiate a database application 106a or object 108a creation and/or modification, and (iii) send a database application or database object definition (e.g., as database application copy 106b or database object copy 108b) to database management system 104. Database application 106a and database object 108a may reside on server 110. Database application 106a may be a set of objects, including tables, queries, forms, reports, macros, code modules, etc., that are stored in a database structure. Database object 108a may be any data structure suitable for organizing or managing database information (e.g., in rows and columns of a table). For instance, database object 108a may be any a table, query, form, report, macro, code module, etc., included in a database application. Database application copy 106b and database object copy 108b may be database application definitions (e.g., temporary local copies) of database application 106a and database object 108a, respectively, accessible from database management system 104. Created database application copies enable a user to create, modify and delete database application objects from the database management system 104. Additionally, embodiments of the disclosure enable a client to obtain versioning information about the server 110 for use when designing database applications.

In certain embodiments, server 110 may be a database management service. Server 110 may support operations to retrieve and edit data in a database application 106a or object 108a stored on an external storage service 112, such as Microsoft® SQL Server® or any database server that supports T-SQL commands. Server 110 may also include support for multi-user access, data integrity, and security functions for various database applications. Server 110 may be a component of a shared services application such as SHAREPOINT®, by Microsoft®, or may be a stand-alone server. Server 110 may also store and retrieve data as submitted and requested by database management system 104. Such systems may reside on the computing device 102 or on another computing device (not shown) configured to communicate with server 110 over a network 114 (e.g., the Internet). Additionally, embodiments may enable server 110 to receive a database application information request or a database object information request from a client and provide the requested database application information or database object information to database management system 104. Server 110 may be configured to notify a client of application-level faults, perform implementation-specific authorization checks, and notify clients of authorization faults. In some embodiments, SOAP faults or HTTP status codes may be utilized to provide notifications. Other notifications methods are also contemplated. Server 110 may be further configured to periodically send updates regarding the status of the create or modify requests to database management system 104 in response to one or more requests submitted by database management system 104. For instance, the server 110 may retrieve and update objects of a database application along with the object and application metadata based on a request from a client.

As shown in FIG. 1, system 100 may also enable server 110 to access an external storage service such as external storage service 112 that stores one or more database applications, such as database application 106a, or one or more database objects, such as database object 108a. Server 110 may be configured to access the external storage service 112 to obtain information or definitions associated with the database application 106a or the database object 108a. In certain embodiments, server 110 may be required to access external storage service 112 through the network 114. In another embodiment, external storage service 112 may be co-located on the same device as server 110. In certain embodiments, the external storage service 112 may be a cloud computing storage service, a file hosting service, or other such service offered by a third party. Examples of such services include SQL Server®, SQL Azure, SKYDRIVE, SHAREPOINT®, and MySite by Microsoft® Corporation of Redmond, Wash., DROPBOX by Officeware Corporation, and the like. Although specific examples have been given, it is contemplated that other external storage services may be used with embodiments disclosed herein.

In one or more server/client configurations, database management system 104 sends a query to server 110 to access a shared database. Generally, a query may be a mechanism by which a user may request a database application action in a database application. A query may include one or more query definitions defining a way to build the query to be used as an object in a database application. In some embodiments, a query may be used for operations such as combining, filtering, sorting, ordering, and grouping of data. Examples of queries may include limiting the results to a subset of the data in the underlying data source, such as certain columns in a table, sorting the results on a combination of one or more columns and expressions, limiting the results to certain records, based on data in the record, creating a new result set from the combination of multiple data sources; top results, limiting the results to return the first specified number or percentage of records; distinct results, limiting the results to return unique rows, describing the groups into which records will be placed in the result set, and/or limiting the results to certain groups of records, based on data in the group of records. A query may reduce the load on a system by returning only a subset of information relevant to a process or an end user. A query can also be used to bring together data from more than one input source. Queries may receive inputs in the form of parameters, which may be included in the output columns as part of an expression or be used to filter the query results. According to embodiments of the disclosure, a query may use expressions in output columns, in restrictions, in groupings, in orderings or in group restrictions to perform calculations or formatting on data.

In certain embodiments, the query is described by XML, which is sent over the network 114 as a Simple Object Access Protocol (SOAP) message. In response to the query, one or more endpoints, including at least one application-level endpoint and at least one server-level endpoint, may be established, which enable database application creation and/or management. Server 110 may be configured to communicate with database management system 104 and return the results of the query to database management system 104. Server 110 and any related operations may be implemented as a web service and may use a standard Internet-based communication protocol such as Hypertext Transfer Protocol (HTTP). Alternatively, requests sent from database management system 104 to server 110 may be in the form of one or more application programming interface (API) calls. To this end, one or more customized database management system APIs may be installed on server 110. Typically, server 110 receives a request from the database management system 104, controls execution of the requested API, and returns the results to the database management system 104.

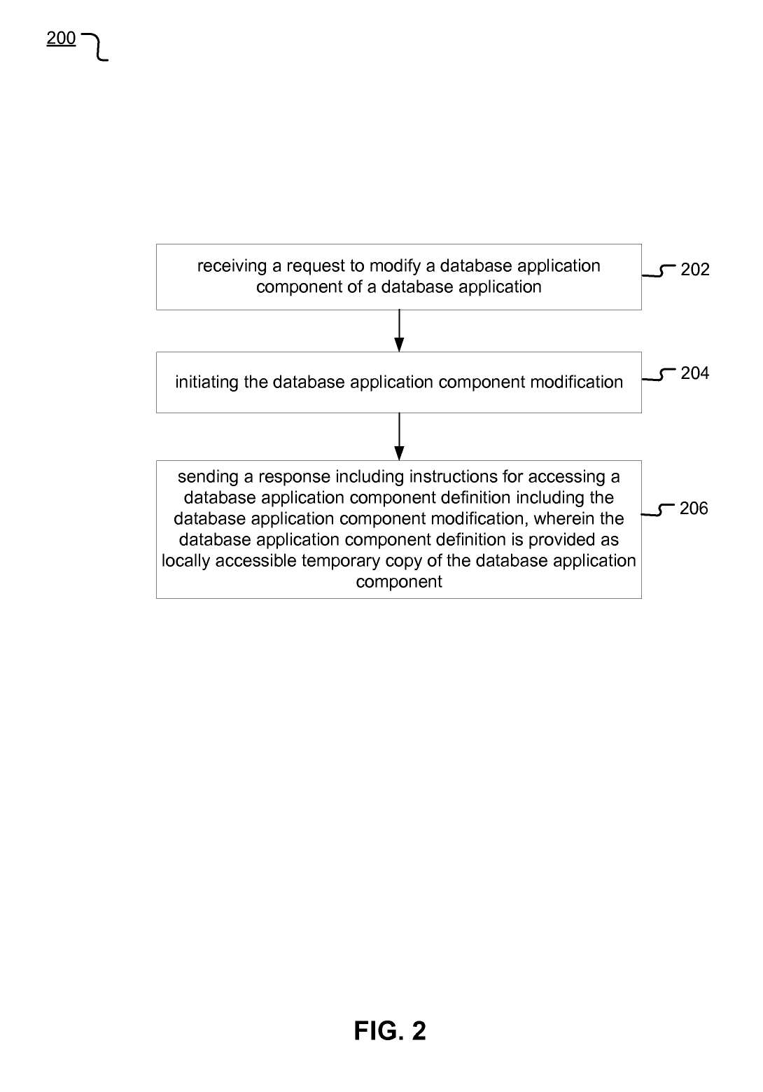

FIG. 2 illustrates a method 200 for creating and modifying database applications and objects according to one or more embodiments. Method 200 may include transmitting database application messages to a remote computing device (e.g., server 110 of FIG. 1) to initiate database application processing requests and responses received from a client (e.g., database management system 104 of FIG. 1). In some embodiments, database application processing requests may be received by and responses may be transmitted from the remote computing device using the Simple Object Access Protocol (SOAP). SOAP messages may include a transport envelope (such as an HTTP or JMS envelope, or the like), a SOAP envelope, a SOAP header and a SOAP body. According to embodiments of the disclosure, a message (SOAP or otherwise) received by server 110 may be defined using the Web Services Description Language (WSDL). WSDL, as used herein, includes an XML format for describing network services (often web services) as a set of endpoints operating on messages containing either document-oriented or procedure-oriented information. The operations and messages may be described abstractly, and then bound to a network protocol and message format to define an endpoint. Related endpoints may be combined into abstract endpoints (services). WSDL is extensible to allow description of endpoints and their messages regardless of what message formats or network protocols are used to communicate. A WSDL definition may be an XML schema that defines the interface, location and encoding scheme for a database application. The definition defines the application, identifies the port through which the application may be accessed (such as an Internet address), and defines the bindings (such as Enterprise Java Bean or SOAP bindings) that are used to invoke the database application and communicate with the application.

Method 200 begins at operation 202, in which a remote computing device receives a database application processing request. Database application processing request may be a request to modify a database application component of a database application. For instance, a client application may call a server 110 to request a database application processing operation. Processing operations may include creating an object, deleting an object, retrieving an object, renaming an object, updating an object, creating a database application package, retrieving a database application package, retrieving application information, retrieving application properties, retrieving application connectivity information, retrieving application connectivity status, adding a firewall rule, deleting a firewall rule, retrieving a firewall rule, retrieving linked table information, refreshing linked table information, retrieving a list of database application themes, importing data, setting database application properties, enabling or disabling database application connectivity, and/or setting data macro tracing. As described above with reference to FIG. 1, the client may retrieve and display a local copy (e.g., database application copy 106b or database object copy 108b) of a database application or database application component in order to initiate a database application processing request.

A database application (e.g., database application 106a of FIG. 1) may be a blank database configured to receive one or more database objects or an external storage service (e.g., external storage service 112 of FIG. 1). One or more database application processing request parameters may also be received by the remote computing device. Parameters may specify information needed by the remote computing device to create the database application. In some embodiments, a database application processing request may be a request to initiate database application creation. To this end, method 200 may include configuring the remote computing device to receive one or more database application creation requests.

Upon receiving the database application processing request and parameters, flow proceeds to operation 204, in which the remote computing device initiates the database application component modification. Prior to initiating the database application component modification, the remote computing device may verify the database application processing request. In some embodiments, one or more remote computing device components may be provisioned and configured to receive the database application processing request. Remote computing device may verify that a database application processing request is properly formatted and includes the elements necessary to process the request, as will be discussed further below.

When the request has been verified, flow proceeds to operation 206 in which the remote computing device provides a response message. For instance, remote computing device may send a response including instructions for accessing a database application component definition including the database application component modification. In some embodiments, the database application component definition is provided as a locally accessible temporary copy of the database application component. For instance, a response message may be provided by the server 110 to the database management system 104. A response message may specify database application information, including one or more database application definitions for the created database application. For instance, server 110 may provide a string specifying a fully qualified uniform resource locator (URL) that points to a successfully created database application. Created database application may be stored on server 110 or on external storage service 112, and a copy of the created database application may be retrieved by any client (e.g., as database application copy 106b of FIG. 1) accessing the remote computing device. Alternatively, if the create request fails, the remote computing device may respond with an error message. A response message may include a database application processing request status. The response message may include an indication of whether the database application processing request was successful, and may confirm completion of the database application processing request.

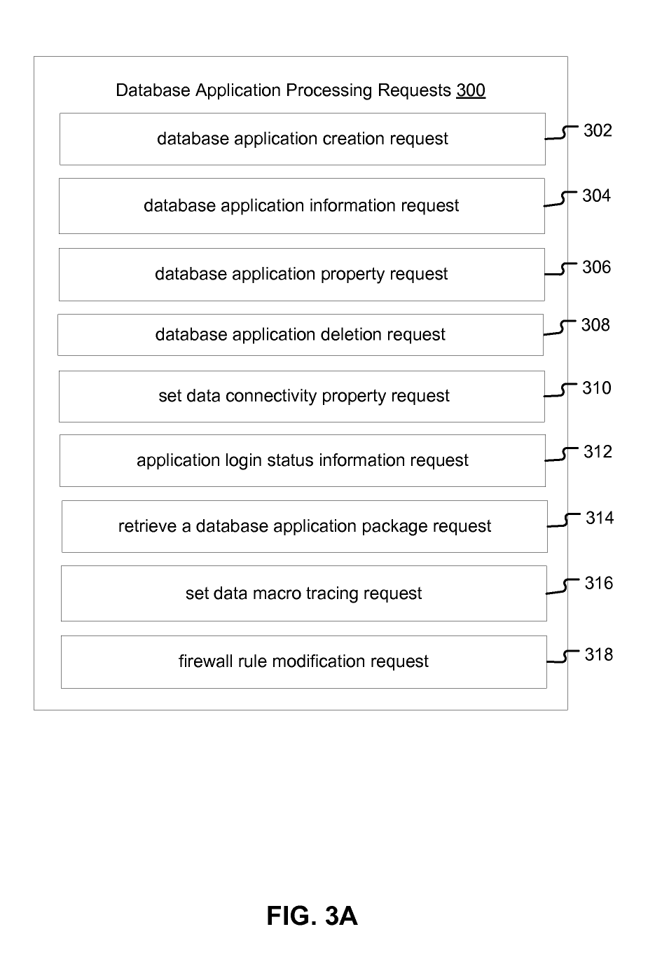

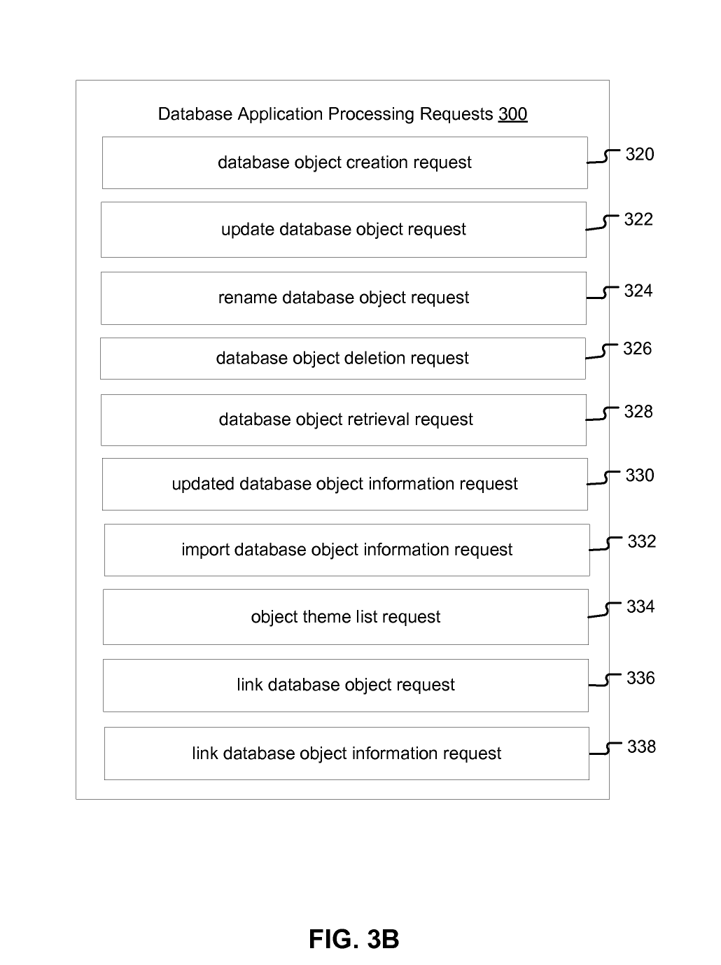

FIGS. 3A-3B are flow diagrams illustrating examples of database application processing requests 300 that may be received and processed by the remote computing device (e.g., in steps 202-206 of method 200). It is to be understood that none of the examples illustrated in FIGS. 3A-3B are necessarily dependent upon another example or are necessarily required to execute prior to execution of a subsequently numbered example. The numbering provided is for reference only. Components from FIG. 1 may be referred to below; however, embodiments of the disclosure are not limited to these components.

In some embodiments, a database application processing request may include receiving a database application creation request 302 from the database management system 104. For instance, server 110 may receive a SetApplicationProperties request and perform a relevant operation. Server 110 may then set one or more specified database application properties. The one or more database application properties may then be retrieved by the server 110 and passed to the client (e.g., database management system 104). In some embodiments, server 110 may perform an application information retrieval operation and retrieve information about a database application. For instance, server 110 may receive a GetApplicationInformation request and perform a relevant operation. In some embodiments, a database application processing request may include receiving database application information request 304 from the database management system 104. Application information may include, for example, metadata or database application version data. Metadata may include any information providing context to the data being processed. Non-limiting examples of metadata may include information pertaining to the origin of data, information pertaining to the location of data, information pertaining to the meaning of data, information pertaining to the age of data, information pertaining to the heading of data, information pertaining to the units of data, information pertaining to a data field and/or any other information relating to the context of the data. The database management system 104 may transmit a database application information request to the remote computing device using an HTTP POST to retrieve information about the database application. In some embodiments, database application information, such as updated identifier attribute and version attribute information, may be returned from the remote computing device in response to the database application information request. Additionally, the remote computing device may return new information regarding database application. For instance, the database application may include one or more new objects (e.g., objects, such as forms, that the database management system 104 had not previously retrieved from the remote computing device). Remote computing device response message may include object information for the new object, including the object definition. The remote computing device may also receive a request for one or more database application properties 306. Server 110 may receive a GetApplicationProperty request and perform a relevant operation. Specifically, server 110 may retrieve a set of property values that exist in a database application. An application properties request may include one or more property parameters such as a property name for a requested property. The remote computing device may return the requested property information if a property definition exists for the requested property.

In some instances, the remote computing device may also receive a request to delete a database application 308. A database management system 104 may send a delete application request message to server 110, which may perform a delete application message operation. A delete application message operation may include one or more parameters specifying the information that the remote computing device needs in order to delete a database application. Server 110 may provide a response message upon successful completion of deleting the database application. Server 110 may delete a database application residing on the remote computing device or external storage service only upon verification that the delete application request was received from the database management system 104 accessing a copy of the latest version of the database application. If the database management system 104 is not accessing a copy of the latest version of the database application, the remote computing device may return the latest version and wait for further instructions from the client. Alternatively, if database application deletion fails, server 110 may respond with a failure message.

In some instances, the remote computing device may also receive a request to set a data connectivity property 310 (e.g., a SetDataConnectivityStatus request). A database management system 104 may send a set data connectivity request message to server 110, which may perform a data connectivity operation. This operation may enable or disable a login to the database application, which is used to connect to the database application directly. In some instances, the database application processing request may be a request 310 for login information to access a created database application in another application. For instance, server 110 may receive a GetDataConnectivity request and perform a relevant operation. Specifically, server 110 may retrieve information about a login for the database application. For instance, at least one other application, such as Microsoft® Visual Studio®, may provide access to a database for viewing or modification. Access to the application may be permitted upon verification of user privileges. User privileges may be obtained from the remote computing device upon querying the remote computing device for login information usable in the other application. The remote computing device may receive a request for application login information from the database management system 104. The database management system 104 may request login information in order to access database application definitions in an application other than the database management system 104 used to create the database application. For instance, once a database application object has been created on the remote computing device, the remote computing device may enable access to a copy of the database application object data via another application. The remote computing device may receive a request for a login having read/write permissions. The remote computing device may generate login information (e.g., username and password information) and present the login information to the client in a dialog. Login information may then be used to access database application information via any other application connected to the remote computing device.

The remote computing device may also receive a request for application login status information 312, and return login status information based on one or more parameters included in the login status information request. For instance, server 110 may receive a GetDataConnectivityStatus request and perform a relevant operation (e.g., retrieve status information about a database application login) and return the status information to the client.

In some instances, the remote computing device may also receive a request to retrieve a database application package 314 representing a database application. Database application package may include database application objects and data. A database management system 104 may send a GetPackage request to server 110, which may perform a get package operation. A get package operation retrieves a package that represents a database application, including its objects and, in some instances, corresponding object data. In some embodiments, remote computing device (e.g., server 110) may provide a database application package to a client (e.g., database management system 104). For instance, server 110 may create a portable version of the data capable of execution and/or storage on another server. Database application package may include the database application and any shared services application components. Package file may be reopened for publishing or republishing on the shared services application, or on the database management system 104. A package may be created, for instance, by a CreatePackage operation. This operation triggers creation of a package that represents a database application, including its objects and, in some instances, corresponding object data. The package can then be retrieved by using, for example, the GetPackage operation.

The remote computing device may further provide data macro tracing to determine whether the remote computing device allows logging the execution of a data macro. For instance, server 110 may receive a SetDataMacroTracing request, and set a data macro tracing option in a database application. A data macro may generally be any business logic running at the level of data that controls the flow of the macro and commands that are performed when the macro is called. For instance, a data macro may consist of one or more statements configured to execute commands such as looking up a record, changing a field value, or raising an error, etc. Each command in the data macro may be specified by an action and zero or more arguments that modify the meaning of the action. A data macro may be configured to run automatically when data is added, changed or removed from a database application, or may run on demand from the database application. A data macro may be a named data macro (e.g., a standalone named object), or may be an embedded data macro (e.g., associated with an event in an object such as a table). A named data macro may be explicitly called through the, for example, a RunDataMacro action. An event data macro may be embedded in an object (e.g., a table) and may be triggered if a specified data event occurs on the table. A data macro associated with a table event may specify an event attribute, which specifies when the macro will be triggered. A named data macro may also specify the names and data types of parameters that may be passed to the macro when it is run. An example of validation logic is the use of a data macro to ensure that a value entered into a column makes sense given other values in a table. After a value is entered into a field (e.g., an EndDate field) of a record, a data macro can be triggered to ensure that the value of that field is later than the value of another field (e.g., a StartDate field) in the same record, or else the record will not be updated. Another example is the use of a data macro to keep the value of a field in one table updated based on entries in another table. For instance, when a new item is created in a “projects” table, a data macro can be triggered to increment a field (e.g., a TotalProjectCount field) in a separate “managers” table, so that each record in the “managers” table includes an up-to-date count of the total number of projects assigned to that manager.

To perform data macro tracing, the remote computing device may receive a set data macro tracing request 316 from database management system 104, and may provide a set data macro tracing response. For instance, a created database application may include a “trace” table. If a trace has been set to run, server 110 may add an entry to the trace table for each statement run in a data macro for the duration of the trace. An added entry may include information about the logic statement and values used by the macro. When a trace is disabled, an entry added to the trace table may remain in the table with no further entries added until another trace is enabled.

The remote computing device may also be configured to receive a request to modify one or more firewall rules 318 related to a created database application. For instance, server 110 may receive an AddFirewallRule request and perform a relevant operation (e.g., add a firewall rule or setting to a database application or database application component) and return a status to the client. Upon verifying the request is valid, the firewall setting may be added to the database application. Server 110 may also receive a request to delete a firewall setting. For instance, server 110 may receive a DeleteFirewallRule request and perform a relevant operation (e.g., delete a firewall rule or setting from a database application or database application component) and return a status to the client. A firewall rule may have been previously added by the AddFirewallRule operation. Upon verifying the request is valid, the firewall setting may be deleted from the database application. The remote computing device may also be configured to retrieve one or more existing firewall settings. For instance, server 110 may receive a GetFirewallRule request and perform a relevant operation (e.g., retrieve a firewall rule or setting from a database application or database application component) and return the retrieved rule or setting to the client. Specifically, upon verifying the request is valid, and that a firewall setting exists for the database application, the firewall setting definition may be returned to the client.

As discussed above, database application processing request may include a database object processing request. For instance, the database management system 104 may have previously retrieved information about a database application residing on a remote computing device (e.g., server 110) or external storage service (e.g., external storage service 112), and so the database application information request may include a list of known objects, including a list of previously retrieved objects. For each object, an identifier attribute and a version attribute may be included in the request. For example, database object processing requests may include creating an object, updating an object, renaming an object, deleting an object, retrieving an object, importing object data, obtaining object theme data, linking database objects, and obtaining information regarding linked database objects. Other database object processing requests are also contemplated. One or more database object request parameters may also be received by the remote computing device. Parameters may specify information needed by the remote computing device to process the database object request. To this end, method 200 may include configuring the remote computing device to receive one or more database object requests. In some embodiments, one or more remote computing device components may be provisioned and configured to receive the database object request. In such instances, the remote computing device may verify the database object request. For instance, remote computing device may verify that a database object request is properly formatted and includes the elements necessary to process the request. Validating the request message may further include verifying that the requested data is available and is properly formatted to be received by the remote computing device. When the database object request has been verified, a response message may be provided by the remote computing device. For example, the response message to a create database object message may include an indication of whether the database object request was successful, and may confirm completion of the database object request. Specifically, the remote computing device may transfer a definition of the requested database object or object modification to the database management system 104 upon receiving and verifying a database object request. In some embodiments, the response message may specify database object information, including one or more database object definitions for a database object. For instance, the remote computing device may provide a string specifying a fully qualified uniform resource locator (URL) that points to the successfully created database object. A created database object may be stored on the remote computing device or on an external storage service, and a copy of the created database object may be retrieved by any client (e.g., as database object copy 108b of FIG. 1) accessing the remote computing device. Alternatively, if the request fails, the remote computing device may respond with an error message.

The remote computing device may also receive a request to create a database object 320, and return the created object. For instance, server 110 may receive a CreateObject request and perform a relevant operation (e.g., create the requested object) and return the object to the client. In certain embodiments, the request may be a client-initiated request to create a database object to be inserted into a database application. The request may be formatted as an XML request, as described above with respect to database application creation, specifying the database application object to be created. Server 110 may be configured to verify that a create object request is correctly formatted and provide a response to the database management system 104 including database object information (e.g., creation success, database object version information, and database object definition). The created database object may be stored on server 110 or on external storage service 112, and may be retrieved by any client (e.g., as database object copy 108b of FIG. 1) accessing the remote computing device. In one example, the database management system 104 may request to have a table created for a database application. Server 110 may receive a message transmitted from the database management system 104 using an HTTP POST to create a table configured for insertion into and manipulation or modification within the specified database application. Server 110 may provide a database object creation response. Creation response may include an identifier attribute uniquely identifying the object within the database application. Creation response may also include a version attribute uniquely identifying an object version. Creation response may also include a definition of the object (e.g., the schema of a table) that was created by the remote computing device. The identifier attribute and version attribute may also be utilized by the client when transmitting an update object request to the remote computing device.

In some embodiments, remote computing device may receive a request to update a database object 322, and return the updated object based on one or more parameters included in the request. For instance, server 110 may receive an UpdateObject request and perform a relevant operation to update an object in a database application. A database object (e.g., database object 108a of FIG. 1) may be any data structure suitable for organizing or managing database information (e.g., in rows and columns of a table). Non-limiting examples of a database object may include a form, table, query, macro, report, or other such database application component. The remote computing device may be configured to define objects in a database application such as constraints and indexes on a table, application variables, user interface command routines, data manipulation routines, and queries. Database object processing requests may include creating an object, deleting an object, retrieving an object, renaming an object, and/or updating an object. Upon receiving a database object processing request, server 110 may verify the object version in the client request and, if the object version attribute of the requested object does not match the latest version token on the remote computing device for the object, the remote computing device may respond with a message including the current definition of the object, or, in some embodiments, an error message. In this manner, server 110 may prevent a user from overwriting changes made by another user to the database application.

The remote computing device may also receive a request to rename an object 324, and return the renamed object. For instance, server 110 may receive a RenameObject request and perform a relevant operation (e.g., rename the requested object) and return the renamed object to the client (e.g., database management system 104). Upon verifying the request is valid, the database application object may be renamed, and a new definition for the object may be passed to the database management system 104 in a response message.

The remote computing device may also receive a request to delete an object 326, and return the created object. For instance, server 110 may receive a DeleteObject request and perform a relevant operation (e.g., delete the requested object) and return object status to the client (e.g., database management system 104). Database management system 104 may send a delete object request to server 110. Delete object request may include one or more parameters specifying the information that server 110 needs in order to delete a database application object. Server 110 may provide a response message upon successful completion of deleting the database application object. The remote computing device may wait to delete a database application object for verification that the delete application object request was received from a client accessing the latest version of the database application object. For instance, as described above, server 110 may verify the object version and, if the object version attribute of the requested object to be deleted does not match the version token on the remote computing device for the object, the remote computing device may respond with a message including the current definition of the object, or, in some embodiments, an error message. The remote computing device may wait for further instructions from the client device. Alternatively, if database application object deletion fails, server 110 may respond with a failure message.

The remote computing device may also receive a request to retrieve an object 328 from a database application, and return the requested object. For instance, server 110 may receive a GetObject request and perform a relevant operation (e.g., retrieve the requested object) and return the requested object to the client (e.g., database management system 104). Database management system 104 may be configured to receive a copy of a database object residing on server 110. The database object may be stored on server 110, on external storage service 112, or on another server or storage service in communication with server 110. In some embodiments, server 110 may receive a request initiated by database management system 104 to retrieve a copy of a database object in a database application. Retrieve object request may include an object definition in the body of the message. Object definition may specify object information including object type (e.g., table, form, query, macro, etc.). Server 110 may receive a request (e.g., a formatted XML request), as described above with respect to database application processing requests, specifying the database application object to be retrieved. Server 110 may verify that a retrieve object request is correctly formatted and provide a response to the database management system 104 including database object information (e.g., retrieval success, database object version, and database object definition). In one example, the database management system 104 may request to have a copy of a table retrieved for a database application. Server 110 may receive a message transmitted from the database management system 104 using an HTTP POST to retrieve a copy of a specified table configured for insertion into and manipulation or modification within the specified database application. The remote computing device may retrieve the requested object and return a copy of the retrieved object to the database management system 104. In some embodiments, this may be referred to as a database object access response. An access response may include an identifier attribute uniquely identifying the object within the database application. An access response may also include a version attribute specifying the object version. An access response may also include a definition of the object (e.g., the schema of a table) that was retrieved by the remote computing device. The identifier attribute and version attribute may also be utilized by the database management system 104 when transmitting an update object request to the remote computing device at a later time.

In some embodiments, server 110 may retrieve the requested object from, for example, external storage service 112, and return created object information to the database management system 104. In such instances, external storage service 112 may be provisioned and configured to communicate with the client and/or server 110 for retrieving a database object, such as database object 108a of FIG. 1, stored on the external storage service. In one embodiment, server 110 may receive a create application request from database management system 104. A database management system user may initiate a create database application processing request from the database management system 104. Use of external storage service 112 enables storage of a database object in a particular location. To retrieve a database object, server 110 may determine a particular identifier associated with the database object stored on the external storage service and submit a request for the database object. When the request is received, the database object is located and returned to the remote computing device. Any changes to the database object may also be saved back into the external storage service.

In some embodiments, the remote computing device may also receive a request for updated database object information 330, and return the requested information. For instance, server 110 may receive an updated object information request, perform a relevant operation (e.g., retrieve the updated object information) and return the requested updated object information to the client (e.g., database management system 104). Database management system 104 may be configured to receive a database object update from server 110. A database object may be stored on server 110, on external storage service 112 or on another server or storage service in communication with the remote computing device, and may be updated or modified by a user. In some embodiments, server 110 may receive a client-initiated request specifying a database object update for a database object in a database application. Update object request may include an object definition in the body of the message. Object definition may specify object information including object type (e.g., table, form, query, macro, etc.). Server 110 may receive a formatted XML request as described above with respect to database application processing requests specifying the database application object for which an update is requested. Server 110 may verify that an update object request is correctly formatted and provide a response to the database management system 104 including database object information (e.g., a database object version and a database object definition). Server 110 may receive a message transmitted from client using an HTTP POST to update a specified object within a specified database application. Server 110 may retrieve information regarding the requested object from, for example, external storage service 112, and return updated object information to database management system 104 in the form of a database object update response. Update response may include an identifier attribute uniquely identifying the object within the database application. Update response may also include a version attribute uniquely identifying an object version. Update response may also include a definition element including the updated definition of the requested object.

In some embodiments, the remote computing device may also receive a request to import database object information 332, and return the requested information. For instance, server 110 may receive an ImportData request, perform a relevant operation (e.g., import the updated object information to a database application on database management system 104). Server 110 may receive a request to import existing data into an object (e.g., a table). Existing data may be stored on the client, server 110, external storage service 112, or elsewhere. The body of the request message may include the XML that contains the full definition of the fields in the object specified by the target object identifier (e.g., the specified table identifier) and the data to be imported into the object. The body of the request message may also include at least one column specification element and at least one row element. Upon verifying the request, server 110 may return imported data to the client. If data is imported, the response message may include the number of rows inserted into the specified table.

In some embodiments, the remote computing device may also receive a request for a list of object themes 334 that may be applied to a database application, and return the requested theme list. For instance, server 110 may receive a GetThemeList request, perform a relevant operation (e.g., retrieve a theme list) and return the requested theme list to the client (e.g., database management system 104). Existing theme data may be stored on the client, server 110, external storage service 112, or elsewhere. The body of the request message may include the XML that contains the full definition of the fields in the object specified by the target object identifier (e.g., the specified table identifier) and the theme data to be retrieved. The body of the request message may also include at least one column specification element and at least one row element. Upon verifying the request, server 110 may return theme data to the client.

In some embodiments, the remote computing device may also receive a link database object request 336 to create a link to a database object (e.g., linked object 118 of FIG. 1) in a database application, perform the requested linking, and return a response to the client (e.g., database management system 104). A linked database object may be, for example, an object residing on a service (e.g., directory service 116 of FIG. 1) external to the remote computing device or the external storage service already in communication with database management system 104. For instance, if the object is a table, the linked object may be a linked table. A table in a database application is a data structure that organizes data as rows and columns. A table schema defines a table in terms of its columns and other properties such as constraints and relationships. Linked tables are tables in a database application whose table structure alone is stored in the backend database while the table data is stored in an external location. Server 110 may receive the linked database object request and return a definition for the created database object link to the database management system 104. For instance, request may be a GetLinkedObject request. Server 110 may create a new linked object (e.g., linked table 118) in a database application and return the definition of the created linked table 118 to the client.

In some embodiments, the remote computing device may also receive a linked database object information request 338 to obtain linked database object information for a database application, retrieve the requested information, and return a response to the client (e.g., database management system 104). In some instances, server 110 may receive a RefreshLinkedObject request. Server 110 may then refresh an existing linked table in a database application on the server 110. Server 110 may identify the linked database object in the database application by an identifier attribute. Server 110 may retrieve an updated linked database object definition from the source of the linked table and return the updated definition to the client. For instance, server 110 may utilize the ID attribute in a RefreshLinkedObjectInformation-Parameters element to identify the linked object in the database application, update an object definition from the source of the linked object, and return the updated object definition to the client.

In further embodiments, server 110 may provide access to the created database to multiple users to enable database application downloading or modification of the copy of the database application or the copy of the database object residing within the database management system 104. Server 100 may enable creation of a new temporary local copy of the database application or object within another database management system 104 (e.g., a database management system 104 other than the one from which the database application was originally created) or other client application. Server 110 may enable access to a created database application stored on the remote computing device for application downloading by a user other than the original creator of the database application. Upon receiving a request to open a created database application, server 110 may return database application information (e.g., metadata, application name, application version information) and any objects associated with the application. Server 110 may also receive a database application snapshot from a client, including database information and objects included in the database application as determined by the client. Server 110 may provide a snapshot of the application, including any objects associated with the application, as determined by the remote computing device. Server 110 may be further configured to indicate one or more differences between the database management system 104 snapshot and the remote computing device snapshot, and provide the database management system 104 with information regarding any other objects the client may need to download.

Server 110 may also store and monitor metadata and version information for a database application or database object. Server 110 may transfer most recent metadata and versioning information in response to client application information or object information requests. Most recent metadata and versioning information is utilized when a client makes changes to the database application or object. Changes may be stored on the remote computing device and the remote computing device may send back additional metadata and version information. In certain embodiments, changes may only be stored if server 110 determines that changes are made to the most recent version of database application or object information associated with a particular database application. In yet another embodiment, server 110 may only return database application information or object information in response to subsequent client requests upon verifying that the request includes the most recent version of database application or object information. In this manner, server 110 may prevent a user from overwriting changes made by another user to the database application.

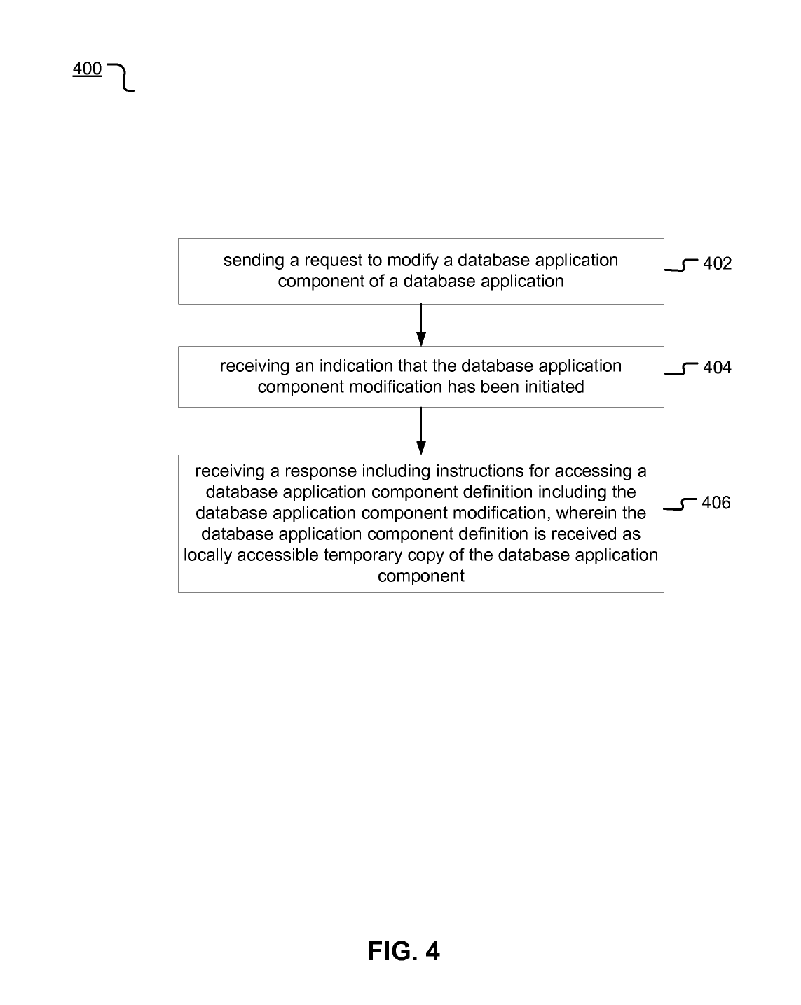

FIG. 4 illustrates a method 400 for sending database application and object modification requests according to one or more embodiments. Method 400 may include sending 402 a request to modify a database application component of a database application. Method 400 may further include receiving 404 an indication that the database application component modification has been initiated. Method 400 may also include receiving 406 a response including instructions for accessing a database application component definition including the database application component modification, wherein the database application component definition is received as locally accessible temporary copy of the database application component. Method 400 may be implemented via any components described above with respect to FIGS. 1-3B, and may include transmitting database application messages to a remote computing device (e.g., server 110 of FIG. 1) to initiate database application processing requests initiated at a client (e.g., database management system 104 of FIG. 1).

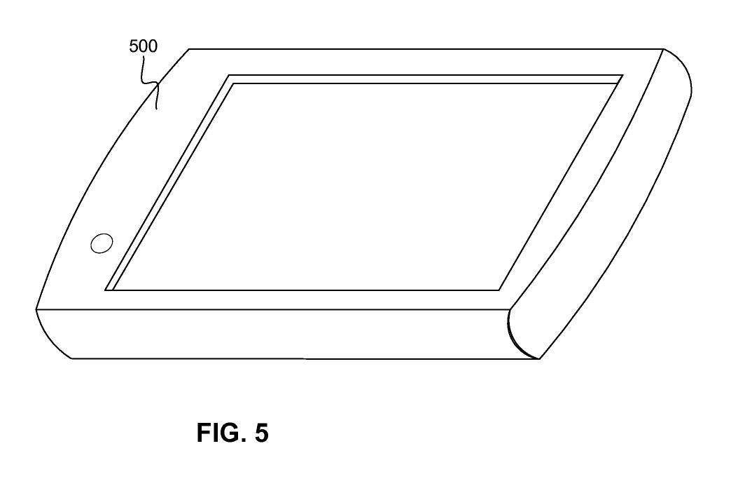

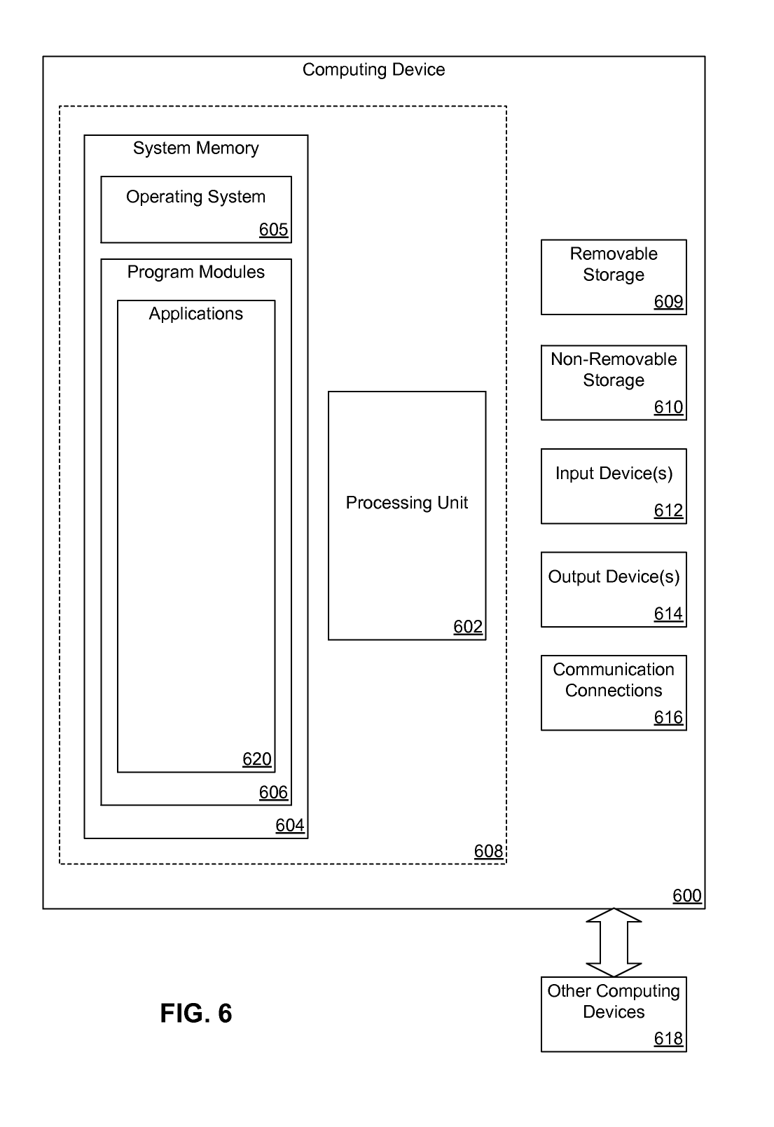

The embodiments and functionalities described herein may operate via a multitude of computing systems including, without limitation, wired and wireless computing systems, mobile computing systems (e.g., mobile telephones, netbooks, tablet or slate type computers, and laptop computers). FIG. 5 illustrates an exemplary tablet computing device 500 executing an embodiment of the paragraph property detection engine 103. In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. FIGS. 6 through 8 and the associated descriptions provide a discussion of a variety of operating environments in which embodiments of the present disclosure may be practiced. However, the devices and systems illustrated and discussed with respect to FIGS. 6 through 8 are for purposes of example and illustration and are not limiting of a vast number of computing device configurations that may be utilized for practicing embodiments of the present disclosure, described herein.

FIG. 6 is a block diagram illustrating exemplary physical components of a computing device 600 with which embodiments of the present disclosure may be practiced. The computing device components described below may be suitable for the computing devices described above. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination. The system memory 604 may include an operating system 605, one or more program modules 606, which are suitable for running applications 620. The operating system 605, for example, may be suitable for controlling the operation of the computing device 600. Furthermore, embodiments of the present disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 may perform processes including, for example, one or more of the stages of the methods described herein. The aforementioned process is an example, and the processing unit 602 may perform other processes. Other program modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the present disclosure, program modules may include routines, programs, components, data structures, and other types of structures that may perform particular tasks or that may implement particular abstract data types. Moreover, embodiments of the present disclosure may be practiced with other computer system configurations, including hand-held devices, multiprocessor systems, microprocessor-based or programmable consumer electronics, minicomputers, mainframe computers, and the like. Embodiments of the present disclosure may also be practiced in distributed computing environments where tasks are performed by remote processing devices that are linked through a communications network. In a distributed computing environment, program modules may be located in both local and remote memory storage devices.

Furthermore, embodiments of the present disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the present disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein may be operated via application-specific logic integrated with other components of the computing device 600 on the single integrated circuit (chip). Embodiments of the present disclosure may also be practiced using other technologies capable of performing logical operations such as, for example, AND, OR, and NOT, including but not limited to mechanical, optical, fluidic, and quantum technologies. In addition, embodiments of the present disclosure may be practiced within a general purpose computer or in any other circuits or systems.

Embodiments of the present disclosure, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. The system memory 604, the removable storage device 609, and the non-removable storage device 610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the computing device 600. Any such computer storage media may be part of the computing device 600. The computing device 600 may also have one or more input device(s) 612 such as a keyboard, a mouse, a pen, a sound input device, a touch input device, etc. The output device(s) 614 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The computing device 600 may include one or more communication connections 616 allowing communications with other computing devices 618. Examples of suitable communication connections 616 include, but are not limited to, RF transmitter, receiver, and/or transceiver circuitry; universal serial bus (USB), parallel, or serial ports, and other connections appropriate for use with the applicable computer readable media.

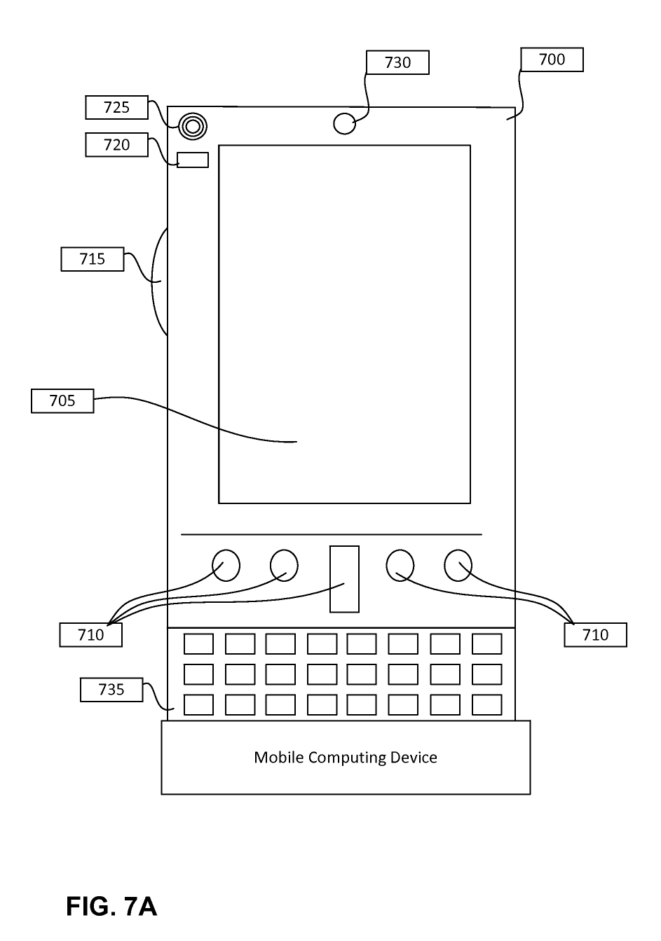

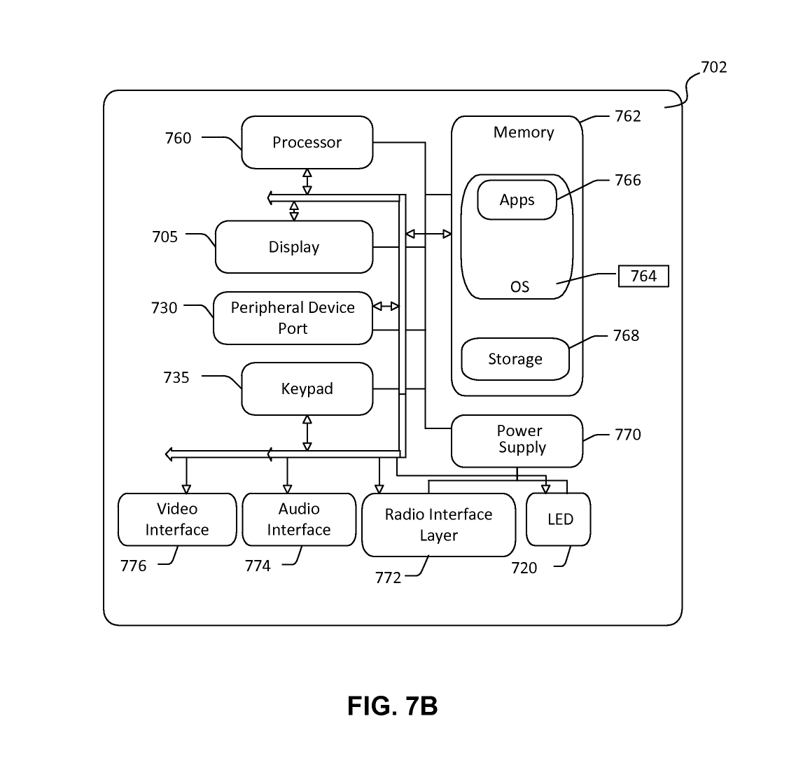

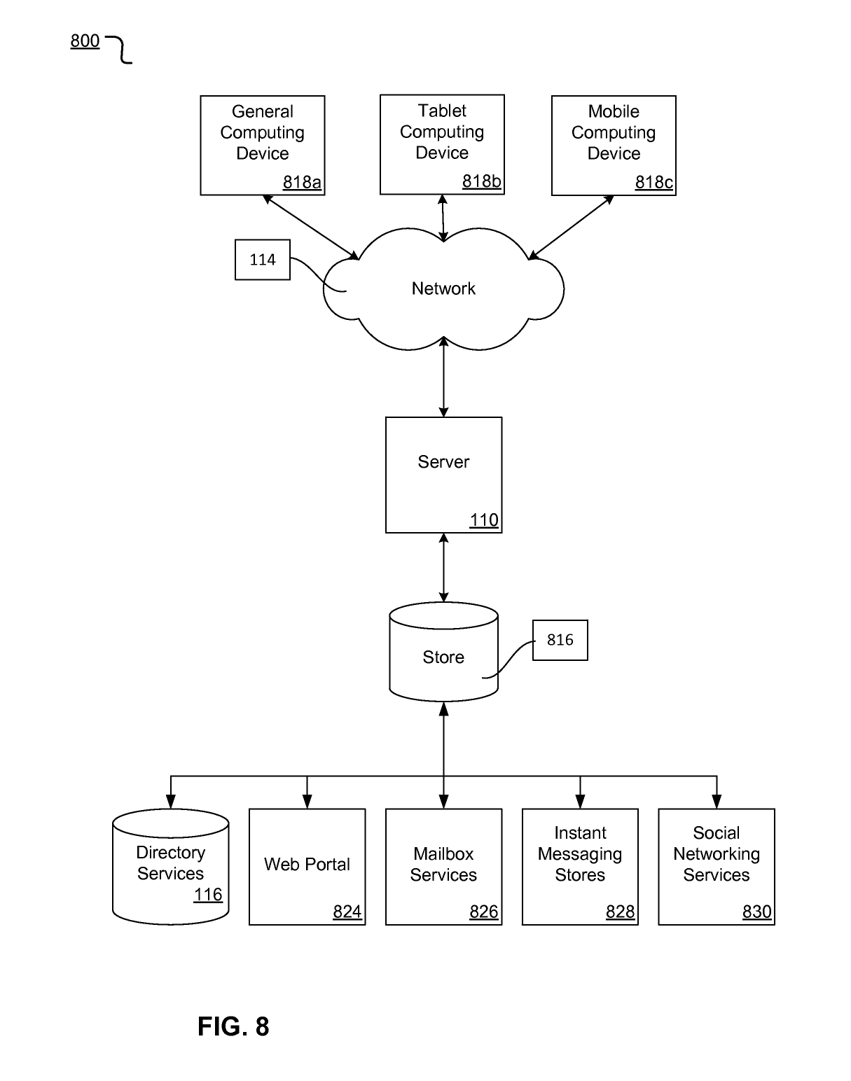

FIGS. 7A and 7B illustrate a mobile computing device 700, for example, a mobile telephone, a smart phone, a tablet personal computer, a laptop computer, and the like, with which embodiments of the present disclosure may be practiced. With reference to FIG. 7A, an exemplary mobile computing device 700 for implementing the embodiments is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included, an optional side input element 715 allows further user input. The side input element 715 may be a rotary switch, a button, or any other type of manual input element. In alternative embodiments, mobile computing device 700 may incorporate more or less input elements. For example, the display 705 may not be a touch screen in some embodiments. In yet another alternative embodiment, the mobile computing device 700 is a portable phone system, such as a cellular phone. The mobile computing device 700 may also include an optional keypad 735. Optional keypad 735 may be a physical keypad or a “soft” keypad generated on the touch screen display. In various embodiments, the output elements include the display 705 for showing a graphical user interface (GUI), a visual indicator 720 (e.g., a light emitting diode), and/or an audio transducer 725 (e.g., a speaker). In some embodiments, the mobile computing device 700 incorporates a vibration transducer for providing the user with tactile feedback. In yet another embodiment, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

Although described herein in combination with the mobile computing device 700, in alternative embodiments, features of the present disclosure may be used in combination with any number of computer systems, such as desktop environments, laptop or notebook computer systems, multiprocessor systems, micro-processor based or programmable consumer electronics, network PCs, mini computers, main frame computers and the like. Embodiments of the present disclosure may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments of the present disclosure.

FIG. 7B is a block diagram illustrating the architecture of one embodiment of a mobile computing device. That is, the mobile computing device 700 can incorporate a system (i.e., an architecture) 702 to implement some embodiments. In one embodiment, the system 702 is implemented as a “smart phone” capable of running one or more applications (e.g., browser, e-mail, calendaring, contact managers, messaging clients, games, and media clients/players). In some embodiments, the system 702 is integrated as a computing device, such as an integrated personal digital assistant (PDA) and wireless phone.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700.

The system 702 has a power supply 770, which may be implemented as one or more batteries. The power supply 770 might further include an external power source, such as an AC adapter or a powered docking cradle that supplements or recharges the batteries.

The system 702 may also include a radio 772 that performs the function of transmitting and receiving radio frequency communications. The radio 772 facilitates wireless connectivity between the system 702 and the “outside world”, via a communications carrier or service provider. Transmissions to and from the radio 772 are conducted under control of the operating system 764. In other words, communications received by the radio 772 may be disseminated to the application programs 766 via the operating system 764, and vice versa.

The radio 772 allows the system 702 to communicate with other computing devices, such as over a network. The radio 772 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of the system 702 provides notifications using the visual indicator 720 that can be used to provide visual notifications and/or an audio interface 774 producing audible notifications via the audio transducer 725. In the illustrated embodiment, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 702 may further include a video interface 776 that enables an operation of an on-board camera 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768. Computer storage media may include volatile and nonvolatile, removable and non-removable media implemented in any method or technology for storage of information, such as computer readable instructions, data structures, program modules, or other data.

Data/information generated or captured by the mobile computing device 700 and stored via the system 702 may be stored locally on the mobile computing device 700, as described above, or the data may be stored on any number of storage media that may be accessed by the device via the radio 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio 772 or via a distributed computing network. Similarly, such data/information may be readily transferred between computing devices for storage and use according to well-known data/information transfer and storage means, including electronic mail and collaborative data/information sharing systems.

FIG. 8 illustrates one embodiment of the architecture of a system for providing converted documents to one or more client devices, as described above. In certain embodiments, the converted documents may be stored in different communication channels or other storage types. For example, various documents, including the converted documents, may be stored using a directory service 116, a web portal 824, a mailbox service 826, an instant messaging store 828, or a social networking site 830. The various components of the system 100 use any of these types of systems or the like for enabling data utilization, as described herein. By way of example, the client computing device 818 may be implemented as the computing device 800 and embodied in a personal computer 818a, a tablet computing device 818b and/or a mobile computing device 818c (e.g., a smart phone). Any of these embodiments of the client computing device 818 may obtain content from the store 816. In various embodiments, the types of networks used for communication between the computing devices that make up the present disclosure include, but are not limited to, an internet, an intranet, wide area networks (WAN), local area networks (LAN), and virtual private networks (VPN). In the present application, the networks include the enterprise network and the network through which the client computing device accesses the enterprise network (i.e., the client network). In one embodiment, the client network is part of the enterprise network. In another embodiment, the client network is a separate network accessing the enterprise network through externally available entry points, such as a gateway, a remote access protocol, or a public or private internet address.

One skilled in the relevant art may recognize, however, that the embodiments may be practiced without one or more of the specific details, or with other methods, resources, materials, etc. In other instances, well known structures, resources, or operations have not been shown or described in detail merely to avoid obscuring aspects of the embodiments.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed:

1. A method for processing a database application request comprising:
receiving a request to modify a database application component of a database application;
initiating the database application component modification; and
sending a response including instructions for accessing a database application component definition including the database application component modification, wherein the database application component definition is provided as a locally accessible temporary copy of the database application component.

2. The method of claim 1, wherein receiving a request to modify a database application component includes receiving a request to obtain a database application package describing a feature of the database application.

3. The method of claim 1, wherein receiving a request to modify a database application component includes receiving a request for updated object versioning information for the database application.

4. The method of claim 1, wherein receiving a request to modify a database application component includes receiving a request to set a data connectivity property of a database application.

5. The method of claim 1, receiving a request to modify a database application component includes receiving a request to set data macro tracing for a database application.

6. The method of claim 1, receiving a request to modify a database application component includes receiving a request to modify a database application firewall rule.

7. The method of claim 1, wherein receiving a request to modify a database application component includes receiving a database object modification request.

8. The method of claim 7, wherein the database object modification request is at least one of an object theme list request or a linked database object request.

9. A computer readable storage medium comprising computer readable instructions for processing a database application request, comprising: instructions for:
receiving a request to modify a database application component of a database application;
initiating the database application component modification; and
sending a response including instructions for accessing a database application component definition including the database application component modification, wherein the database application component definition is provided as a locally accessible temporary copy of the database application component.

10. The computer readable storage medium of claim 9, wherein receiving a request to modify a database application component includes receiving a request to obtain a database application package describing a feature of the database application.

11. The computer readable storage medium of claim 9, wherein receiving a request to modify a database application component includes receiving a request for updated object versioning information for the database application.

12. The computer readable storage medium of claim 9, wherein receiving a request to modify a database application component includes receiving a request to set a data connectivity property of a database application.

13. The computer readable storage medium of claim 9, receiving a request to modify a database application component includes receiving a request to set data macro tracing for a database application.

14. The computer readable storage medium of claim 9, receiving a request to modify a database application component includes receiving a request to modify a database application firewall rule.

15. The computer readable storage medium of claim 9, wherein receiving a request to modify a database application component includes receiving a database object modification request, further including receiving a request to retrieve a database object theme list or a linked database object.

16. A method for requesting a database application modification comprising:
sending a request to modify a database application component of a database application;
receiving an indication that the database application component modification has been initiated; and
receiving a response including instructions for accessing a database application component definition including the database application component modification, wherein the database application component definition is received as a locally accessible temporary copy of the database application component.

17. The method of claim 16, wherein sending a request to modify a database application component includes sending a request to obtain a database application package describing a feature of the database application

18. The method of claim 16, wherein sending a request to modify a database application component includes sending a request for updated object versioning information for the database application.

19. The method of claim 16, wherein sending a request to modify a database application component includes sending a request set a data connectivity property of a database application.

20. The method of claim 16, wherein sending a request to modify a database application component includes sending a database object modification request, further including sending a request to retrieve a database object theme list or a linked database object.
